(19) United States
(12) Patent Application Publication
(10) Pub. No.: US 2013/0151516 A1
(43) Pub. Date: Jun. 13, 2013

(54) CLINICAL DATA ANALYSIS APPARATUS AND CLINICAL DATA ANALYSIS METHOD

(71) Applicant: Chan Yong PARK, Daejeon (KR)

(72) Inventor: Chan Yong PARK, Daejeon (KR)

(73) Assignee: Electronics and Telecommunications Research Institute, Daejeon (KR)

(21) Appl. No.: 13/620,264

(22) Filed: Sep. 14, 2012

(30) Foreign Application Priority Data
Dec. 8, 2011 (KR) 10-2011-0131106

(51) Int. Cl. G06F 17/30

(52) U.S. Cl. 707/736; 707/E17.005

(57) ABSTRACT

Provided are a clinical data analysis apparatus and a clinical data analysis method. The clinical data analysis apparatus includes a statistical process unit and a statistical analysis unit. The statistical process unit is configured to collect and store first clinical data or second clinical data and statistically process the first clinical data so as to provide the processed first clinical data as statistical data. The statistical analysis unit refers to the statistical data and the second clinical data to verify correlation between the second clinical data and the statistical data or predict a progression of a disease of a patient from whom the second clinical data are collected. The statistical analysis unit provides a result of the verification or the prediction to a user terminal as medical data.

### CROSS-REFERENCE TO RELATED APPLICATIONS

This U.S. non-provisional patent application claims priority under 35 U.S.C. §119 of Korean Patent Application No. 10-2011-0131106, filed on Dec. 8, 2011, the entire contents of which are hereby incorporated by reference.

### BACKGROUND OF THE INVENTION

The present invention disclosed herein relates to a clinical data analysis apparatus and a clinical data analysis method thereof, and more particularly, to a clinical data analysis apparatus and a clinical data analysis method for providing useful medical information by statistically analyzing clinical data.

Medical institutions store medical records containing information such as names of diseases, symptoms, body temperatures, and blood pressures.

Information included in medical records such as medical history, constitutions, medication history, and effectiveness of medication are used as reference when treating or healing the same patient.

With the development and spread of computerized equipment, electric medical record systems are being widely used to computerize medical records and store computerized medical records in computers. Specific examples of electric medical record systems are disclosed in Korean Patent Application Laid-open Publication Nos.: 2010-0053995 and 2010-0101396.

However, the functions of such electric medical record systems are merely to computerize and store medical records. That is, other functions than storing and searching of medical records are not provided.

### SUMMARY OF THE INVENTION

The present invention provides a clinical data analysis apparatus and a clinical data analysis method for providing useful medical information by statistically analyzing clinical data.

The present invention also provides a clinical data analysis apparatus and a clinical data analysis method for predicting the progression or prognosis of a disease of a patient.

The present invention also provides a clinical data analysis apparatus and a clinical data analysis method for transmitting an information message by detecting the health state of a patient.

The present invention also provides a clinical data analysis apparatus and a clinical data analysis method using more reliable statistical analysis.

Embodiments of the present invention provide clinical data analysis apparatuses including: a statistical process unit configured to collect and store first clinical data or second clinical data and statistically process the first clinical data to provide the processed first clinical data as statistical data; and a statistical analysis unit referring to the statistical data and the second clinical data to verify correlation between the second clinical data and the statistical data or predict a progression of a disease of a patient from whom the second clinical data are collected, the statistical analysis unit providing a result of the verification or the prediction to a user terminal as medical data.

In some embodiments, the user terminal may include a patient's terminal, a relative's terminal, or a doctor's terminal

In other embodiments, the statistical process unit may include: a clinical database storing the first clinical data and the second clinical data; a statistical process module statistically processing the first clinical data for providing the processed first clinical data as statistical data; and a statistical database storing the statistical data.

In still other embodiments, the first clinical data may be statistically processed by at least one of a chi-square test, a T-test, a correlation test, a variance analysis, and a regression analysis.

In even other embodiments, the statistical analysis unit may include a verification module referring to the statistical data and the second clinical data so as to verify correlation between the second clinical data and the statistical data and provide a result of the verification to the user terminal as medical data.

In yet other embodiments, the statistical analysis unit may include a prediction module referring to the statistical data and the second clinical data so as to predict the progression of the disease of the patient from whom the second clinical data are collected, the prediction module providing a result of the prediction to a user terminal as medical data.

In further embodiments, the statistical analysis unit may include a risk detection unit configured to provide a warning signal according to whether the medical data has a dangerous value or guideline condition.

In still further embodiments, the clinical data analysis apparatus further includes a message transmission unit configured to provide an information message to the user terminal by referring to the warning signal.

In even further embodiments, the medical data or the information message may be provided to the user terminal through a wired or wireless communication network.

In yet further embodiments, the clinical data analysis apparatus may receive a doctor's opinion on the medical data as an opinion input value from the user terminal.

In some embodiments, whether to add the second clinical data to the first clinical data may be determined according to the opinion input value.

In other embodiments, the result of the verification or the prediction may be verification of a stoke or prediction about progression to a stroke.

In still other embodiments, the first clinical data or the second clinical data may include hospital medical record data or u-health data.

In even other embodiments, the u-health data may include at least one of weight, blood pressure, blood sugar, and HsCRP of the patient.

In other embodiments of the present invention, clinical data analysis methods include: collecting and storing first clinical data or second clinical data; statistically processing the first clinical data so as to generate statistical data; referring to the statistical data so as to verify correlation between the second clinical data and the statistical data or predict a progress of a disease of a patient from whom the second clinical data are collected; and providing a result of the verification or the prediction to a user terminal as medical data.

In some embodiments, the second clinical data may be u-health data collected from the patient.

In other embodiments, the user terminal may include a patient's terminal, a relative's terminal, or a doctor's terminal.

In still other embodiments, the clinical data analysis method may further include providing an information message to the patient's terminal, the relative's terminal, or the doctor's terminal according to whether the medical data has a dangerous value or guideline condition.

In even other embodiments, the information message may include a warning message for a health risk, a message advising the patient to go to the doctor, or a message giving information about available medical institutions.

In yet other embodiments, the clinical data analysis method may further include: receiving a doctor's opinion on the medical data as an opinion input value from the user terminal; and adding the second clinical data to the first clinical data according to the opinion input value.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a clinical data analysis apparatus according to an embodiment of the present invention;

FIG. 2 is a block diagram illustrating a statistical process unit of FIG. 1;

FIG. 3 is a block diagram illustrating a statistical analysis unit of FIG. 1;

FIG. 4 is a view for explaining a method of predicting the progression of a disease according to a first embodiment of the present invention;

FIG. 5 is a view for explaining a method of predicting the progression of a disease according to a second embodiment of the present invention;

FIG. 6 is a flowchart for explaining a clinical data analysis method according to an embodiment of the present invention; and

FIG. 7 is a flowchart for explaining a clinical data analysis method according to another embodiment of the present invention.

### DETAILED DESCRIPTION OF PREFERRED EMBODIMENTS

It should be construed that foregoing general illustrations and following detailed descriptions are exemplified and an additional explanation of claimed inventions is provided. The present invention may be embodied in different forms and should not be construed as limited to the embodiments set forth herein. Rather, these embodiments are provided so that the present invention will be thorough and complete, and will fully convey the scope of the present invention to those skilled in the art.

In the specification, it will be understood that when a part or unit is referred to as comprising or including an element, it can comprise or include another element. Hereinafter, exemplary embodiments of the present invention will be described with reference to the accompanying drawings.

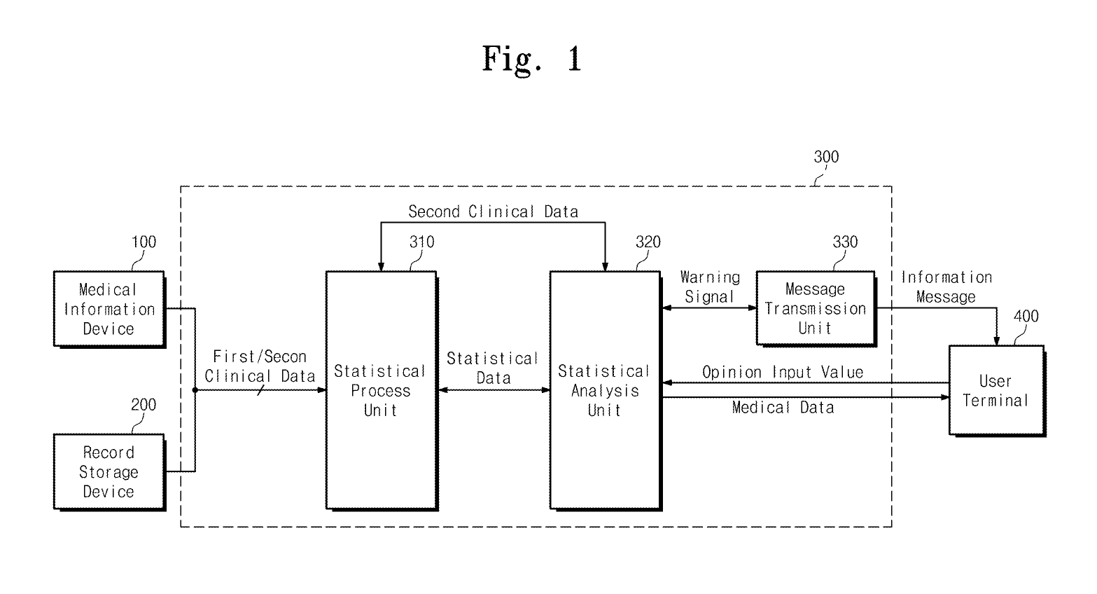

FIG. 1 is a block diagram illustrating a clinical data analysis apparatus 300 according to an embodiment of the present invention. Referring to FIG. 1, the clinical data analysis apparatus 300 includes a statistical process unit 310, a statistical analysis unit 320, and a message transmission unit 330.

The clinical data analysis apparatus 300 receives first clinical data or second clinical data from a medical information device 100 or a record storage device 200.

The first clinical data is used as a population for generating statistical data (described later). The second clinical data is clinical data to be statically analyzed. The clinical data analysis apparatus 300 provides clinical data to a user terminal 400. In an embodiment, examples of the user terminal include a patient's terminal, a relative's terminal, and a doctor's terminal. The user terminal may be a computing device having a central processing unit (CPU) or other devices. For example, the user device may be a simple receiver capable of receiving alarms or messages.

The medical information device 100 collects ubiquitous-health (u-health) data from a patient and provides the collected u-health data to the clinical data analysis apparatus 300 as first clinical data or second clinical data. The medical information device 100 may be a data transmission device such as a set-top box, a TV, a cellular phone, or a tablet PC. In an embodiment, the medical information device 100 may include an electric medical diagnosis device. U-health data collected by the medical information device 100 may include patient's bio-data such as weight, blood pressure, blood sugar, or high sensitivity C-reactive protein (HsCRP) values. The value of HsCRP is used to predict blood vessel diseases. For example, the value of HsCRP is helpful to predict or diagnose a stroke.

The record storage device 200 is a device for computerizing and storing hospital medical records. Hospital medical records include data about patients treated or healed in a hospital, such as disease names, symptoms, body temperatures, and blood pressures. The record storage device 200 provides hospital medical records to the clinical data analysis apparatus 300 as first clinical data or second clinical data.

The clinical data analysis apparatus 300 includes the statistical process unit 310 and the statistical analysis unit 320.

The statistical process unit 310 receives first or second clinical data from the medical information device 100 or the record storage device 200. The clinical data may be transmitted through a wire telephone network, the internet, a wireless fidelity (WIFI) network, or a mobile communication network. In an embodiment, the clinical data may be encoded for protecting personal information. In this case, the statistical process unit 310 may include a decoder (not shown) for decoding the encoded clinical data.

The statistical process unit 310 stores the first or second clinical data in a database thereof. The first clinical data are statistically processed, and the processed result is stored as statistical data. That is, the first clinical data are used as a population for generating statistical data. Like clinical data, the statistical data are stored in the database of the statistical process unit 310. In an embodiment, the statistical process unit 310 may store clinical data and statistical data in separate databases, respectively. For example, clinical data may be stored in a clinical database, and statistical data may be stored in a statistical database. Although the clinical database and the statistical database may be included in the same hardware, the clinical database and the statistical database are provided in different regions.

The first clinical data may be statistically processed by various mathematical statistical analysis methods. Various kinds of statistical data may be generated through various statistical methods according to purposes. That is, the kind of statistical data is determined by a statistical method used for creating the statistical data.

In an embodiment, examples of statistical methods may include a chi-square test, a T-test, a correlation test, a variance analysis, and a regression analysis.

The T-test is a test method using t distribution. In the T-test, whether means (μ1, μ2) of normal populations N (μ1, σ21) and N (μ2, σ22) are equal may be tested using sample data extracted from the normal populations N (μ1, σ21) and N (μ2, σ22). In addition, the T-test may be used to test whether a sample mean calculated from sample data extracted from a normal population is equal to a population mean.

The correlation test is a statistical method for numerically analyzing the kind and degree of correlation between a plurality of factors. Particularly, the result of a correlation test is expressed as a mathematical function in the regression analysis.

The variance analysis is a statistical method for analyzing the reason of variance of a plurality of measured values. In the variance analysis, experimental conditions are divided based on factors, and analysis is performed based on each factor to estimate the reason of variance. Specifically, in the variance analysis, effects on variance are divided into an effect (factor variation) by a specific factor and effects (residual variation) by the other factors. The effect by the specific factor is evaluated by comparing the factor variation and the residual variation.

If factor variation is caused by one factor, one-way variance analysis is used. If factor variation is caused by two factors, two-way variance analysis is used. If factor variation is caused by three or more factors, multi-way variance analysis is used.

The regression analysis is a statistical method for predicting casual relationship between a plurality of variables. The regression analysis is carried out by analyzing a functional formula between two variables (an independent variable and a dependent variable) having a casual relationship. In the regression analysis, a mathematical linear functional formula having a plurality of variables is analyzed to predict correlation between the variables. The mathematical linear functional formula is called a regression formula. Since the regression analysis is used to determine the casual relationship between variables, the regression analysis is different from the correlation test used to analyze only the correlation between variables.

The regression analysis is a useful tool for examining a hypothesis through an empirical analysis. If a regression formula is provable, a dependent variable can be estimated or predicted.

Regression analysis with one independent variable is called simple regression analysis, and regression analysis with two independent variables is called multiple regression analysis.

Since the above-described statistical methods are well known, detailed descriptions thereof will be omitted.

The statistical analysis unit 320 receives a statistical command from the user terminal 400. According to the statistical command, the statistical analysis unit 320 reads second clinical data and statistical dada from the statistical process unit 310. The statistical analysis unit 320 statistically analyzes the second clinical data while referring to the statistical data. Through the statistical analysis, the statistical analysis unit 320 may verify correlation between the second clinical data and the statistical data received from the statistical process unit 310. For example, through the statistical analysis, the statistical analysis unit 320 may estimate or predict the progression of a disease of a patient from whom the second clinical data are collected. In addition, the statistical analysis unit 320 may estimate a prognosis for the patient of the second clinical data. Detailed procedures and methods for the statistical analysis of the statistical analysis unit 320 will be described later with reference to the accompanying drawings.

The result of the statistical analysis (correlation verification or disease progression prediction) carried out by the statistical analysis unit 320 is transmitted to the user terminal 400 as medical data.

In addition, the statistical analysis unit 320 analyzes or checks medical data to produce a warning signal if the medical data contains a dangerous value or guideline condition. The dangerous value or guideline condition may be set to any value by a user or the clinical data analysis apparatus 300. For example, a dangerous value of 80 may be set to medical data implying the possibility of a stroke, and if medical data having a dangerous value of 80 appears, the statistical analysis unit 320 may generate a warning signal. The warning signal is transmitted to the message transmission unit 330 for generating an information message.

The message transmission unit 330 provides an information message to the user terminal 400 based on the warning signal. In an embodiment, the information message may advise a patient to go to the doctor or provide information about a suitable medical institution.

In addition, the clinical data analysis apparatus 300 may receive a doctor's opinion input value from the user terminal 400. In an embodiment, the doctor's opinion input value may be input to the statistical analysis unit 320.

The doctor's opinion input value means a doctors' clinical opinion offered based on given medical data. For example, if information about the progression of a patient's disease is given as medical data, a doctor may examine the medical data while referring to second clinical data so as to determine whether the information is proper. Then, the doctor may provide a clinical opinion as an opinion input value based on the determination.

The clinical data analysis apparatus 300 compares the opinion input value with the medical data. If the opinion input value agrees with the medical data, the clinical data analysis apparatus 300 determines that the second clinical data used to generate the medical data are valid. If the opinion input value does not agree with the medical data, the clinical data analysis apparatus 300 determines that the second clinical data used to generate the medical data are invalid.

The clinical data analysis apparatus 300 adds the second clinical data determined to be valid to first clinical data. Then, the first clinical data used as a population for generating statistical data are increased. Since the population increases, the next statistical data can be generated more reliably.

In an embodiment, when second clinical data are added to first clinical data, an opinion input value may also be added to the first clinical data. In an embodiment, the statistical process unit 310, the statistical analysis unit 320, or an additional process unit (not shown) may receive an opinion input value and determine whether second clinical data are valid.

According to the above-described configuration of the present invention, medical data can be provided by analyzing clinical data of a patient. In addition, the progression or prognosis of a patient's disease can be predicted. In addition, the correlation between statistical data and patient's clinical data can be verified.

In addition, clinical data used as a population for preparing statistical data can be increased by referring to a doctor's opinion input value offered based on medical data. As a result, more reliable statistical data can be provided.

Furthermore, the clinical data analysis apparatus 300 may collect u-health data from the daily life of a patient. In addition, statistical analysis results may be used as reference medical data to automatically check a health risk of a patient. If it is checked that the condition of the patient's health is dangerous, an information message is sent to a user (patient, relative, or doctor). The information message may include a warning message giving information about the progression of a disease or the possibility of a disease or a massage advising a patient to go to the doctor.

In this way, the condition of patient's health can be first diagnosed before the patient goes to the doctor or a doctor give a clinical opinion. Owing to this, patients may largely reduce their medical costs. Furthermore, dangerous health conditions of patients can be detected in early stages.

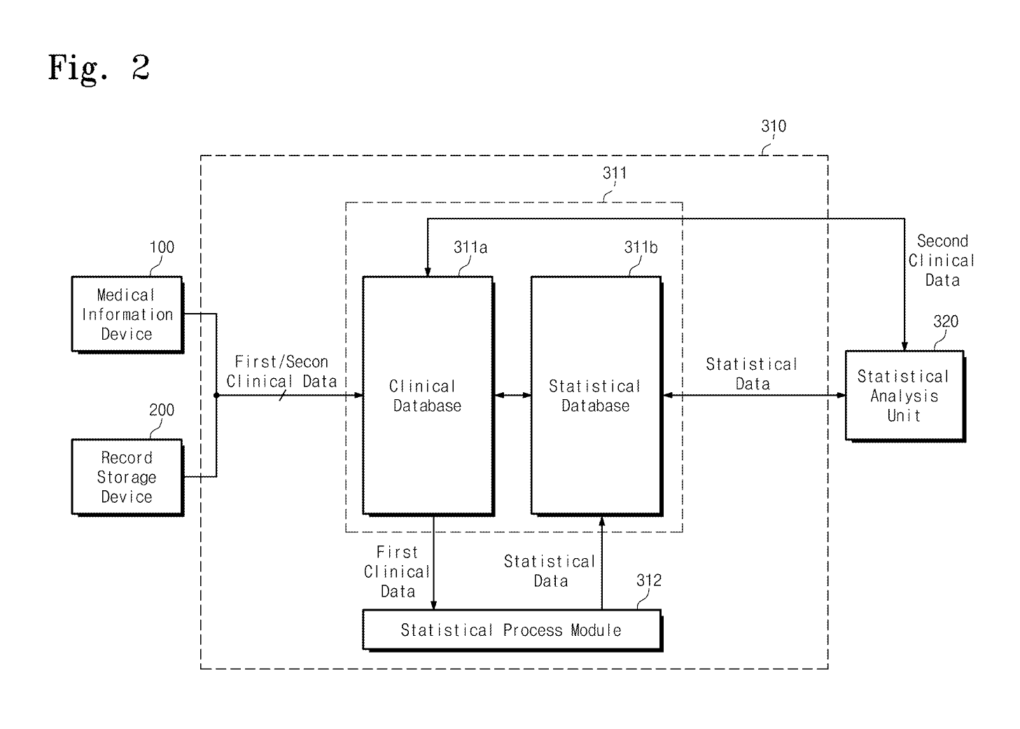

FIG. 2 is a block diagram illustrating the statistical process unit 310. Referring to FIG. 2, the statistical process unit 310 includes a database 311 and a statistical process module 312. The database 311 includes a clinical database 311a and a statistical database 311b.

The database 311 receives first or second clinical data from the medical information device 100 or the record storage device 200 and stores the first or second clinical data in the clinical database 311a. The clinical data stored in the clinical database 311a may include personal information, treatment information, blood sample information, stroke information, patient's medical history, test conditions, and u-health data. In an embodiment, each item of the clinical data may include measurement data and time information.

The first clinical data stored in the database 311 is provided to the statistical process module 312. The first clinical data is used as a population for generating statistical data. The second clinical data is provided to the statistical analysis unit 320 for statistical analysis (described later). The statistical process module 312 statistically processes the first clinical data for generating statistical data. The statistical process module 312 may use statistical methods such as a chi-square test and a T-test. Alternatively, the statistical process module 312 may use other mathematical statistical methods for generating statistical data.

For example, if a user requests an analysis on the correlation between HsCRP and HDL cholesterol, a correlation coefficient between HsCRP and HDL cholesterol may be generated as statistical data.

In another example, the statistical process module 312 may perform a T-test based on HsCRP on a group (first group) of patients having a medical history of diabetes and a group (second group) of patients not having a medical history of diabetes. The statistical process module 312 may determine whether HsCRP values of the first and second groups are equal and may generate the determination result as statistical data.

The statistical process module 312 may perform a particular statistical process in response to a user's request. In addition, although there is no user's request, the statistical process module 312 may continue a particular statistical process according to preset conditions and generate the result of the statistical process as statistical data. For example, if the statistical process module 312 is set to consistently perform a statistical process on blood pressures, HsCRP, or blood sugar, the statistical process module 312 may perform the statistical process regularly or each time when new clinical data are received or clinical data are updated so as to generate statistical data.

The statistical process module 312 performs a statistical process in the same statistical method as that of the statistical process unit 310 described with reference to FIG. 1.

The statistical process module 312 provides statistical data to the database 311. The statistical data is stored in the statistical database 311b of the database 311.

The statistical database 311b computerizes the statistical data and then stores the statistical data. The statistical database 311b and the clinical database 311a may be provided in the same hardware. In this case, however, the statistical database 311b is provided in a region different from that of the clinical database 311a. For example, the statistical database 311b may be provided in a memory block logically and physically separated from the clinical database 311a.

The statistical database 311b provides the statistical data to the statistical analysis unit 320. In addition, the statistical database 311b may communicate with the statistical analysis unit 320 and the clinical database 311a through interfaces.

For example, the statistical database 311b receives a request for particular statistical data from the statistical analysis unit 320. Then, the statistical database 311b searches for the requested statistical data. If the requested statistical data are stored, the statistical database 311b provides the stored statistical data to the statistical analysis unit 320. On the contrary, if the requested statistical data are not stored, the statistical database 311b transmits a signal to the clinical database 311a for generating statistical data. Then, the clinical database 311a selects clinical data necessary for generating statistical data and transmits the selected clinical data to the statistical process module 312. The statistical database 311b stores statistical data generated by the statistical process module 312 and transmits the statistical data to the statistical analysis unit 320.

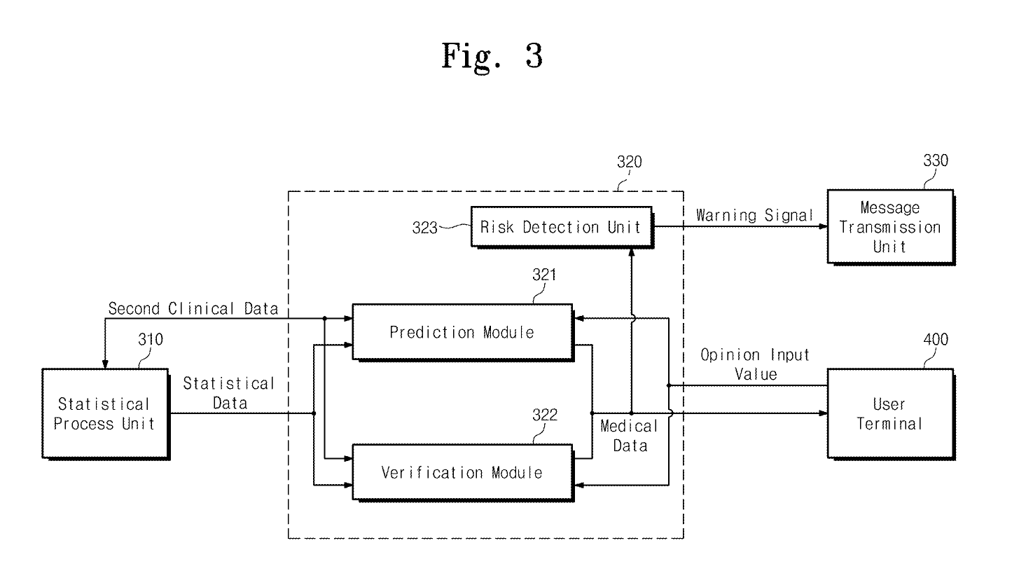

FIG. 3 is a block diagram illustrating the statistical analysis unit 320 illustrated in FIG. 1. Referring to FIG. 3, the statistical analysis unit 320 includes a prediction module 321 and a verification module 322.

The verification module 322 receives statistical data and second clinical data from the statistical process unit 310. The second clinical data are clinical data collected from patients for statistical analysis. While referring to the statistical data, the verification module 322 verifies correlation between the statistical data and the second clinical data and sends the result of verification to the user terminal 400 as medical data. The verification module 322 may verify the second clinical data be checking whether the second clinical data have general clinical values based on the statistical data.

In detail, the verification module 322 selects a population from first clinical data to generate statistical data. Then, the verification module 322 determines a statistical analysis method to be used for data verification. Next, the verification module 322 determines measurement items of the statistical analysis method. In an embodiment, the statistical analysis method may be a chi-square test or a T-test. The measurement items may include blood pressure, blood sugar, age, or HsCRP. The second clinical data may be used as a treatment group, and the population may be used as a control group.

That is, a T-test may be performed on the treatment group and the control group based on HsCRP. The result of the T-test may give information about whether clinical data of the treatment group and the control group have statistically meaningful correlation. For example, the verification module 322 may verify whether HsCRP values measured from a treatment group administered with medication (A) are different in statistically meaningful degree from HsCRP values measured from a control group not administered with medication (A).

The prediction module 321 receives the statistical data and the second clinical data from the statistical process unit 310. Based on the statistical data and the second clinical data, the prediction module 321 predicts the progression of a disease of a patient from whom the second clinical data are collected, and the prediction module 321 provides the prediction result to the user terminal 400 as medical data.

In detail, the prediction module 321 analyzes a clinical data model that is statistically similar to the second clinical data and derived from the statistical data. Then, with reference to the disease progression in the clinical data model, the prediction module 321 predicts the progression of a disease of a patient from whom the second clinical data are collected.

The prediction module 321 may use regression analysis as prediction algorism. For example, the prediction module 321 may use regression analysis for predicting the progression of a stroke of a patient. In detail, the prediction module 321 collects stroke data models from statistical data and selects one of the stroke data models that has a stable progression pattern (patient model). Then, based on the patient model, the prediction module 321 assumes a regression parameter and predicts the progression of a disease of a patient using the assumed regression parameter.

A method of predicting the progression of a disease of a patient using the prediction module 321 will be described later in more detail.

A risk detection unit 323 determines whether a patient has a risk based on medical data received from the prediction module 321 or the verification module 322. For example, if a value of medical data is in a dangerous range, the prediction module 321 may generate a warning signal. In addition, if a value of medical data corresponds to a guideline condition preset in the clinical data analysis apparatus 300, the prediction module 321 may generate a warning signal. In an embodiment, the guideline condition may be set by a user (or doctor or apparatus operator). The warning signal is transmitted to the message transmission unit 330 for generating an information message.

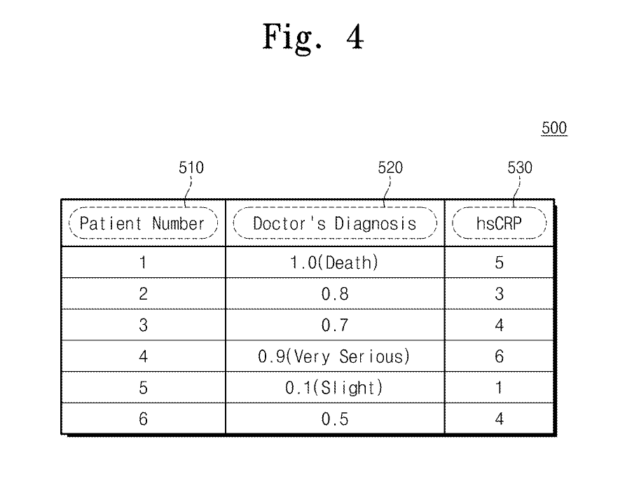

FIG. 4 is a view for explaining a method of predicting the progression of a disease according to a first embodiment of the present invention. Referring to

FIG. 4, clinical data (A) 500 includes three fields: a patient number field 510, a doctor's diagnosis field 520, and an HsCRP field 530.

The patient number field 510 identifies patients listed in the clinical data (A) 500. The patient number field 510 includes FIGS. 1 to 6) to indicate six patients.

The doctor's diagnosis field 520 is a field in which doctor's clinical decisions on the progression states of patient's diseases are recorded. The doctor's diagnosis field 520 includes clinical decisions on the respective six patients indicated by the patient number field 510. In the doctor's diagnosis field 520, a higher value means a more serious state of a disease. For example, the value “1” in the doctor's diagnosis field 520 means dead. The value “0.1” means a slight state.

The HsCRP field 530 contains measured HsCRP values. The HsCRP field 530 contains HsCRP values measured from the respective six patients listed in the patient number field 510.

In the current embodiment, the statistical process unit 310 (refer to FIG. 1) performs a simple regression analysis on the clinical data (A) 500 and stores a regression coefficient as statistical data. The prediction module 321 (refer to FIG. 3) predicts the progression of another patient's disease by referring to the regression coefficient.

Specifically, in the simple regression analysis, a regression equation Yᵢ=a+bXᵢ is determined, where (i) indicates the number of each patient, Yᵢ indicates a doctor's diagnosis value given to a patient (i), Xᵢ indicates an HsCRP value of the patient (i).

The statistical process unit 310 inputs the doctor's diagnosis values and the HsCRP values of the clinical data (A) 500 to the regression equation to calculate the values of regression coefficients (a) and (b).

In an embodiment, the regression coefficients (a) and (b) may be calculated using the clinical data (A) 500 by a least squares method or a machine learning method.

The calculated regression coefficients (a) and (b) are stored in the statistical database 311b (refer to FIG. 2) of the statistical process unit 310.

The prediction module 321 determines the regression equation of Yᵢ=a+bXᵢ by referring to the regression coefficients stored in the statistical database 311b. Then, the HsCRP value of another patient (patient K) whose disease state will be predicted is input to Xᵢ of the regression equation so as to calculate the value of Yᵢ. The calculated Yᵢ indicates the disease state of the patient K. The calculated Yᵢ is a prediction value for the progression of a disease of the patient K but is not a measured value. However, the progression of a patient's disease can be statistically predicted by the prediction module 321 without a doctor's clinical decision.

As described above, according to the embodiment of the present invention, the progression of a patient's disease can be predicted or estimated without a doctor's clinical decision. In addition, u-health data can be collected from patient's daily life, and the health condition of the patient can be automatically determined using the collected u-health data. If it is checked that the condition of the patient's health is dangerous, an information message is automatically sent to a user (patient, relative, or doctor). The information message may include a warning message for a health risk, a message advising a patient to go to the doctor, or a message giving information about available medical institutions.

That is, reference data or a warming signal can be provided for a patient by using only a statistical method. As a result, a dangerous health state of a patient can be automatically detected. In addition, since the health state of a patient can be checked at any time, a dangerous state of the patient can be diagnosed at an early stage. In addition, since the health state of a patient can be checked without having to see the doctor or requiring a doctor's clinical decision, medical costs can be reduced.

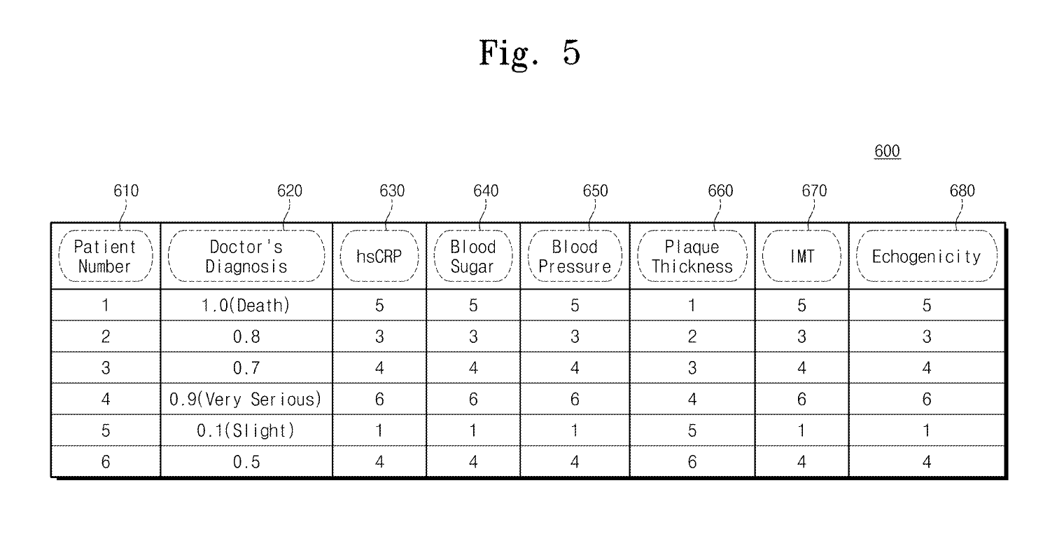

FIG. 5 is a view for explaining a method of predicting the progression of a disease according to a second embodiment of the present invention. Referring to FIG. 5, clinical data (A) 600 includes eight fields: a patient number field 610, a doctor's diagnosis field 620, an HsCRP field 630, a blood sugar field 640, a blood pressure field 650, a plaque field 660, an intima-media thickness (IMT) field 670, and an echogenicity field 680. The clinical data (A) 600 includes more independent variable fields than the clinical data (A) 500. Thus, in the second embodiment, multiple regression analysis is performed.

The patient number field 610 identifies patients listed in the clinical data (A) 600. The patient number field 610 includes FIGS. 1 to 6) to indicate six patients.

The doctor's diagnosis field 620 is a field in which doctor's clinical decisions on the progression states of patient's diseases are recorded. The doctor's diagnosis field 620 includes clinical decisions on the respective six patients indicated by the patient number field 610. In the doctor's diagnosis field 620, a higher value means a more serious state of a disease. For example, the value “1” in the doctor's diagnosis field 620 means dead. The value “0.1” means a slight state.

The HsCRP field 630 contains measured HsCRP values. The HsCRP field 630 contains HsCRP values measured from the respective six patients listed in the patient number field 610.

Similarly, the blood sugar field 640, the blood pressure field 650, the plaque field 660, the IMT field 670, and the echogenicity field 680 contain blood sugar values, blood pressure values, plaque thickness values, IMT values, and echogenicity values, respectively. Blood sugar values, blood pressure values, plaque thickness values, IMT values, and echogenicity values that are measured from the six patients listed in the patient number field 610 are shown in the blood sugar field 640, the blood pressure field 650, the plaque field 660, the IMT field 670, and the echogenicity field 680, respectively.

In the current embodiment, the statistical process unit 310 (refer to FIG. 1) performs a multiple regression analysis on the clinical data (A) 600 and stores regression coefficients as statistical data. The prediction module 321 (refer to FIG. 3) predicts the progression of another patient's disease by referring to the regression coefficients.

Specifically, in the multiple regression analysis, a regression equation Yᵢ=a+b₁X₁ᵢ+b₂X₂ᵢ+ . . . +b₆X₆ᵢ is determined, where (i) indicates the number of each patient, Yᵢ indicates a doctor's diagnosis value given to a patient (i), X₁ᵢ to X₆ᵢ indicate an HsCRP value, a blood sugar value, a blood pressure value, a plaque thickness value, an IMT value, and an echogenicity value of the patient (i).

The statistical process unit 310 inputs the doctor's diagnosis values and the values of the independent variables (HsCRP values, blood sugar values, blood pressure values, plaque thickness values, IMT values, and echogenicity values) of the clinical data (A) 600 to the regression equation so as to calculate the values of regression coefficients a, b₁, b₂ . . . b₆.

In an embodiment, the regression coefficients a, b₁, b₂ . . . b₆ may be calculated using the clinical data (A) 600 by a least squares method or a machine learning method.

The calculated regression coefficients are stored in the statistical database 311b (refer to FIG. 2) of the statistical process unit 310.

The prediction module 321 determines the regression equation of Yᵢ=a+b₁X₁ᵢ+b₂X₂ᵢ+ . . . +b₆X₆ᵢ by referring to the regression coefficients stored in the statistical database 311b. Then, the HsCRP value, blood sugar value, blood pressure value, plaque thickness value, IMT value, and echogenicity value of another patient (patient J) whose disease state will be predicted is input to X₁ᵢ to X₆ᵢ of the regression equation so as to calculate the value of Yᵢ. The calculated Yᵢ indicates the disease state of the patient J.

Like that explained with reference to FIG. 4, the calculated Yᵢ is a prediction value for the progression of a disease of the patient J but is not a measured value. However, the progression of a patient's disease can be statistically predicted by the prediction module 321 without a doctor's clinical decision.

Clinical data may include more independent variables than the independent variables introduced in the current embodiment. In this case, only some of the independent variables may be selected to calculate corresponding regression coefficients. That is, a plurality of regression equations may be used according to clinical data, and a user can calculate predicted disease states using the plurality of regression equations, respectively. Thus, a user can get or provide various results of disease state prediction.

In addition, the clinical data of the patient J may be transmitted to the statistical process unit 310 for using the clinical data as new clinical data.

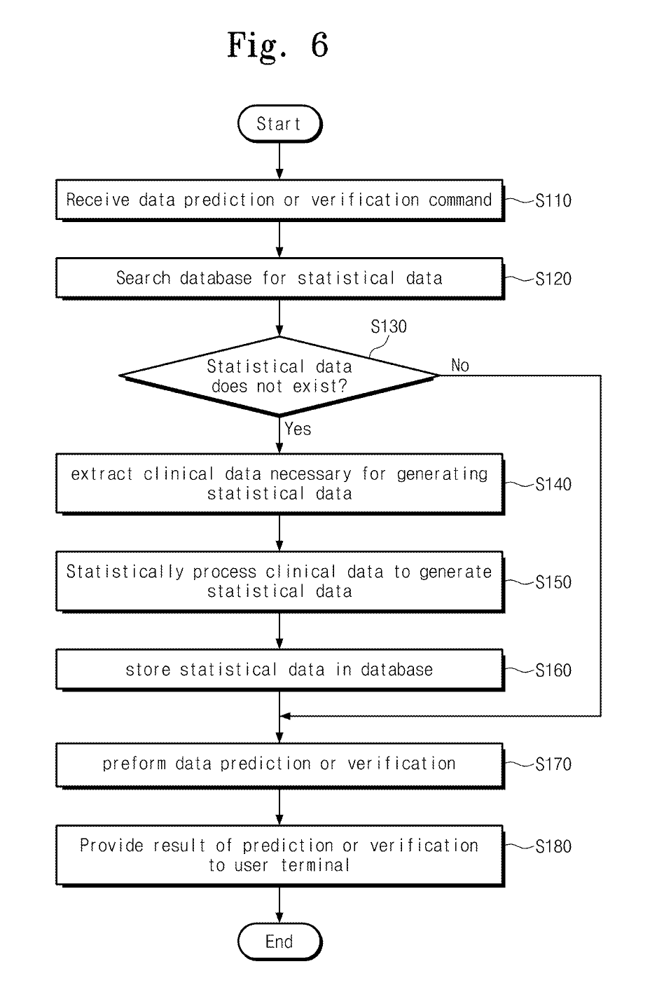

FIG. 6 is a flowchart for explaining a clinical data analysis method according to an embodiment of the present invention. Referring to FIG. 6, the clinical data analysis method includes operations S110 to S180.

In operation S110, the clinical data analysis apparatus 300 (refer to FIG. 1) receives a data prediction command or a data verification command from a user. In an embodiment, the data prediction command may be a command requesting the clinical data analysis apparatus 300 to predict the progression of a patient's disease. The data verification command may be a command requesting the clinical data analysis apparatus 300 to verify correlation between collected clinical data.

In operation S120, the clinical data analysis apparatus 300 searches the statistical database 311b (refer to FIG. 2) to find statistical data for performing a process corresponding to the received command. For example, if the received command is a disease state prediction command, the statistical database 311b is searched to fine regression coefficients as statistical data.

In operation S130, it is determined whether desired statistical data are in the statistical database 311b. If desired statistical data are not in the statistical database 311b, the procedure goes to operation S140. If desired statistical data are in the statistical database 311b, the procedure goes to operation S170.

In operation S140, the statistical process module 312 (refer to FIG. 2) selects or extracts clinical data (first clinical data) from the clinical database 311a (refer to FIG. 2) to generate statistical data.

In operation S150, the statistical process module 312 statistically processes the selected clinical data (first clinical data) to generate statistical data. Methods that can be used by the statistical process module 312 to generate statistical data have been explained in the above description.

In operation S160, the statistical process module 312 provides the generated statistical data to the statistical database 311b. The statistical database 311b stores the received statistical data and provides the statistical data to the statistical analysis unit 320.

In operation S170, the statistical analysis unit 320 performs a data prediction operation or a data verification operation while referring to the statistical data and second clinical data. In an embodiment, the data prediction operation may be performed by the prediction module 321, and the data verification operation may be performed by the verification module 322. Specific operations of the prediction module 321 and the verification module 322 are described in the above description.

In operation S180, the statistical analysis unit 320 transmits the result of the data prediction operation or the data verification operation to the user terminal 400 (refer to FIG. 1). Data transmission from the statistical analysis unit 320 may be performed through a wired or wireless communication network. The user terminal 400 may be a personal computer (PC), a tablet PC, a smart phone, or a smart TV.

In addition, the statistical analysis unit 320 may generate a warning signal based on the result of the data prediction operation or the data verification operation, so as to provide an information message to the user terminal 400. In an embodiment, the information message may be provided through the message transmission unit 330 (refer to FIG. 1). Specific configurations and methods for generating warning signals and information messages are described in the above description.

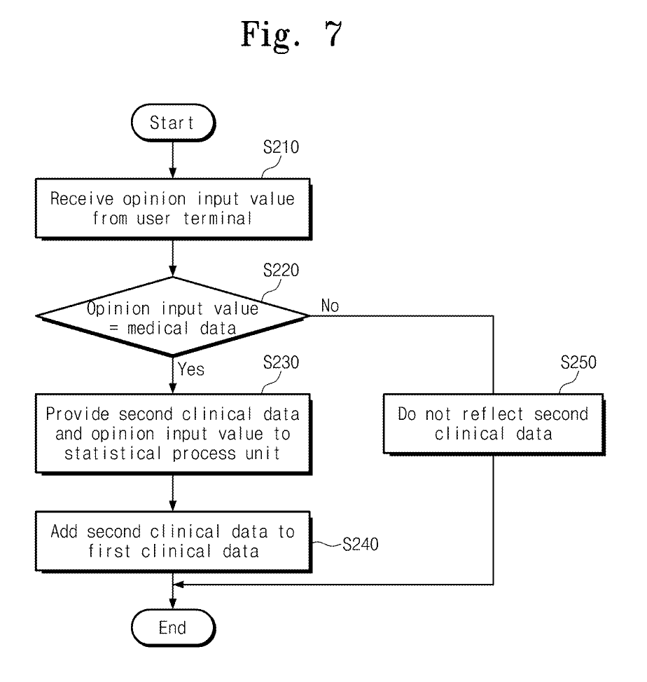

FIG. 7 is a flowchart for explaining a clinical data analysis method according to another embodiment of the present invention. Referring to FIG. 7, a clinical data analysis method for adding second clinical data to first clinical data is illustrated. In detail, the clinical data analysis method of the current embodiment includes operations S210 to 240.

The current embodiment is provided on the premise that medical data have been provided to the user terminal 400 (refer to FIG. 1) based on statistical data and second clinical data. The medical data have been provided as described above.

In operation S210, the clinical data analysis apparatus 300 (refer to FIG. 1) receives an opinion input value from the user terminal 400. The opinion input value refers to the result of a doctor's opinion whether the medical data are clinically suitable. In an embodiment, the opinion input value may include a doctor's opinion whether the medical data are prepared by suitably analyzing the second clinical data. In addition, the opinion input value may include information about doctor's disease prediction or opinion on the progression of a disease offered based on the second clinical data.

In operation S220, the clinical data analysis apparatus 300 compares the medical data with the opinion input value. If the medical data agrees with the opinion input value, the procedure goes to operation S230. On the other hand, if the medical data does not agree with the opinion input value, the procedure goes to operation S250.

In operation S230, the clinical data analysis apparatus 300 determines that the second clinical data corresponding to the medical data are valid. The second clinical data determined to be valid are provided to the statistical process unit 310 (refer to FIG. 1). According to an embodiment, in the clinical data analysis apparatus 300, the opinion input value may be provided to the statistical process unit 310 together with the second clinical data.

In operation S240, the statistical process unit 310 adds the second clinical data or the opinion input value to first clinical data. The second clinical data or the opinion input value may be included in a population as first clinical data for generating statistical data.

In operation S220, if the opinion input value does not agree with the medical data, the procedure goes to operation S250.

In operation S250, the clinical data analysis apparatus 300 determines that the second clinical data corresponding to the medical data are invalid. Then, the clinical data analysis apparatus 300 does not add the invalid second clinical data to the first clinical data.

According to the above-described clinical data analysis method, clinical data (second clinical data) determined to be valid by a doctor can be added to first clinical data. Therefore, a population (first clinical data) for generating statistical data can be increased. As a result, more reliable statistical data can be generated in the next process.

The above-disclosed subject matter is to be considered illustrative, and not restrictive, and the appended claims are intended to cover all such modifications, enhancements, and other embodiments, which fall within the true spirit and scope of the present invention. While specific terms were used in the specification, they were not used to limit the meaning or the scope of the invention described in claims, but merely used to explain the inventive concept. Thus, to the maximum extent allowed by law, the scope of the present invention is to be determined by the broadest permissible interpretation of the following claims and their equivalents, and shall not be restricted or limited by the foregoing detailed description.

What is claimed is:

1. An clinical data analysis apparatus comprising:
a statistical process unit configured to collect and store first clinical data or second clinical data and statistically process the first clinical data to provide the processed first clinical data as statistical data; and
a statistical analysis unit referring to the statistical data and the second clinical data to verify correlation between the second clinical data and the statistical data or predict a progression of a disease of a patient from whom the second clinical data are collected, the statistical analysis unit providing a result of the verification or the prediction to a user terminal as medical data.

2. The clinical data analysis apparatus of claim 1, wherein the user terminal comprises a patient's terminal, a relative's terminal, or a doctor's terminal.

3. The clinical data analysis apparatus of claim 1, wherein the statistical process unit comprises:
a clinical database storing the first clinical data and the second clinical data;
a statistical process module statistically processing the first clinical data for providing the processed first clinical data as statistical data; and
a statistical database storing the statistical data.

4. The clinical data analysis apparatus of claim 3, wherein the first clinical data is statistically processed by at least one of a chi-square test, a T-test, a correlation test, a variance analysis, and a regression analysis.

5. The clinical data analysis apparatus of claim 1, wherein the statistical analysis unit comprises a verification module referring to the statistical data and the second clinical data so as to verify correlation between the second clinical data and the statistical data and provide a result of the verification to the user terminal as medical data.

6. The clinical data analysis apparatus of claim 1, wherein the statistical analysis unit comprises a prediction module referring to the statistical data and the second clinical data so as to predict the progression of the disease of the patient from whom the second clinical data are collected, the prediction module providing a result of the prediction to the user terminal as medical data.

7. The clinical data analysis apparatus of claim 1, wherein the statistical analysis unit comprises a risk detection unit configured to provide a warning signal according to whether the medical data has a dangerous value or guideline condition.

8. The clinical data analysis apparatus of claim 7, further comprising a message transmission unit configured to provide an information message to the user terminal by referring to the warning signal.

9. The clinical data analysis apparatus of claim 8, wherein the medical data or the information message is provided to the user terminal through a wired or wireless communication network.

10. The clinical data analysis apparatus of claim 1, wherein the clinical data analysis apparatus receives a doctor's opinion on the medical data as an opinion input value from the user terminal

11. The clinical data analysis apparatus of claim 10, wherein whether to add the second clinical data to the first clinical data is determined according to the opinion input value.

12. The clinical data analysis apparatus of claim 1, wherein the result of the verification or the prediction is verification of a stoke or prediction about progression to a stroke.

13. The clinical data analysis apparatus of claim 1, wherein the first clinical data or the second clinical data comprise hospital medical record data or u-health data.

14. The clinical data analysis apparatus of claim 13, wherein the u-health data comprise at least one of weight, blood pressure, blood sugar, and HsCRP of the patient.

15. A clinical data analysis method comprising:
collecting and storing first clinical data or second clinical data;
statistically processing the first clinical data so as to generate statistical data;
referring to the statistical data so as to verify correlation between the second clinical data and the statistical data or predict a progress of a disease of a patient from whom the second clinical data are collected; and
providing a result of the verification or the prediction to a user terminal as medical data.

16. The clinical data analysis method of claim 15, wherein the second clinical data are u-health data collected from the patient.

17. The clinical data analysis method of claim 15, wherein the user terminal comprises a patient's terminal, a relative's terminal, or a doctor's terminal.

18. The clinical data analysis method of claim 17, further comprising providing an information message to the patient's terminal, the relative's terminal, or the doctor's terminal according to whether the medical data has a dangerous value or guideline condition.

19. The clinical data analysis method of claim 18, wherein the information message comprises a warning message for a health risk, a message advising the patient to go to the doctor, or a message giving information about available medical institutions.

20. The clinical data analysis method of claim 15, further comprising:
receiving a doctor's opinion on the medical data as an opinion input value from the user terminal; and
adding the second clinical data to the first clinical data according to the opinion input value.
